(19) United States
(12) Patent Application Publication
(10) Pub. No.: US 2012/0294039 A1
(43) Pub. Date: Nov. 22, 2012

(54) DISPLAY AND LIGHT GUIDE THEREOF

(75) Inventors: Chen-Wei FAN, Chu-Nan (TW); Jui-Wen PAN, Chu-Nan (TW)

(73) Assignees: NATIONAL CHIAO-TUNG UNIVERSITY, Hsinchu (TW); CHIMEI INNOLUX CORPORATION, Chu-Nan (TW)

(21) Appl. No.: 13/470,221

(22) Filed: May 11, 2012

(30) Foreign Application Priority Data
May 16, 2011 (TW) 100117015

(51) Int. Cl. F21V 8/00; G02B 6/26; G02B 6/34

(52) U.S. Cl. 362/611; 385/36; 385/15

(57) ABSTRACT

A light guide is provided, including a guiding layer, a reflective layer and an intermediary layer. The guiding layer includes a first upper surface and a first lower surface, wherein a guiding layer micro-structure is formed on the first upper surface, and the guiding layer has a guiding layer refractive index. The reflective layer includes a second upper surface and a second lower surface, wherein a reflective layer micro-structure is formed on the second lower surface, and the reflective layer has a reflective layer refractive index. The intermediary layer is sandwiched between the guiding layer and the reflective layer, and contacts the first lower surface of the guiding layer and the second upper surface of the reflective layer, wherein the intermediary layer has an intermediary layer refractive index, and the intermediary layer refractive index is smaller than the guiding layer refractive index and the reflective layer refractive index.

### CROSS REFERENCE TO RELATED APPLICATIONS

This Application claims priority of Taiwan Patent Application No. 100117015, filed on May 16, 2011, the entirety of which is incorporated by reference herein.

### BACKGROUND OF THE INVENTION

1. Field of the Invention

The present invention relates to a light guide, and in particular relates to a light guide utilized in a display.

2. Description of the Related Art

FIG. 1 shows a conventional light guide 1 and light source 2. The light guide 1 includes a first surface 11 and a second surface 12. The first surface 11 is opposite to the second surface 12. A first micro-structure is formed on the first surface 11. A second micro-structure is formed on the second surface 12. The first micro-structure on the first surface 11 is utilized to control the uniformity of light, and the second micro-structure on the second surface 12 is utilized to control and focus the direction of light. Conventionally, the light provided by the light source 2 is focused by the second micro-structure on the second surface 12. However, the second micro-structure on the second surface 12 is formed by injection molding, which has a simple structure, and a poor functionality of focusing the light, and cannot sufficiently collimate the light provided by the light source 2.

### BRIEF SUMMARY OF THE INVENTION

A light guide is provided, including a guiding layer, a reflective layer and an intermediary layer. The guiding layer includes a first upper surface and a first lower surface, wherein a guiding layer micro-structure is formed on the first upper surface, and the guiding layer has a guiding layer refractive index. The reflective layer includes a second upper surface and a second lower surface, wherein a reflective layer micro-structure is formed on the second lower surface, and the reflective layer has a reflective layer refractive index. The intermediary layer is sandwiched between the guiding layer and the reflective layer, and contacts the first lower surface of the guiding layer and the second upper surface of the reflective layer, wherein the intermediary layer has an intermediary layer refractive index, and the intermediary layer refractive index (n₂) is smaller than the guiding layer refractive index and the reflective layer refractive index.

In the embodiment of the invention, the intermediary layer with lower refractive index is disposed between the guiding layer and the reflective layer. The intermediary layer helps to control directions of the light. Without the intermediary layer, the light cannot be sufficiently guided by the guiding layer. Utilizing the first embodiment of the invention, the display can provide highly-collimating light with a simple reflective layer micro-structure.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional light guide and light source;

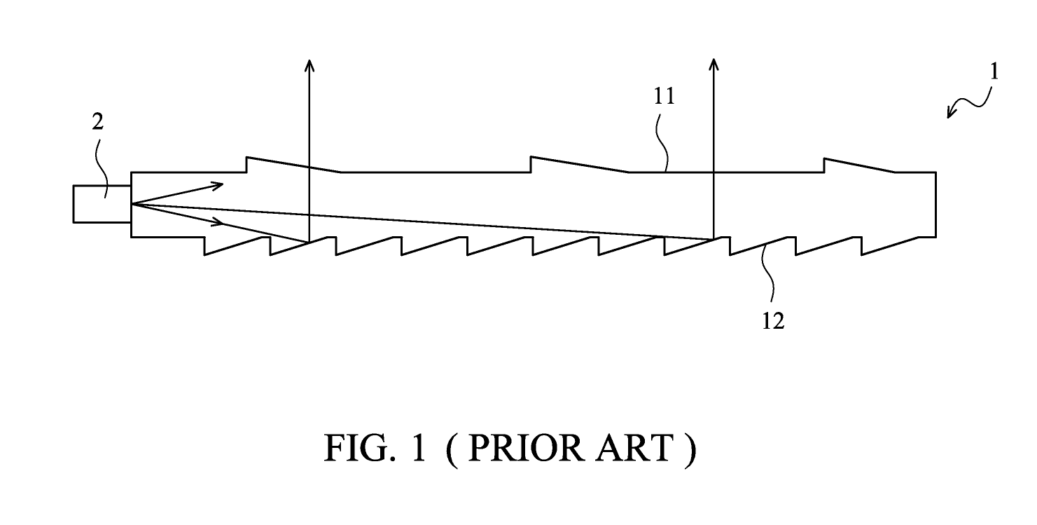

FIG. 2 shows a display of a first embodiment of the invention; and

FIG. 3 shows a display of a second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

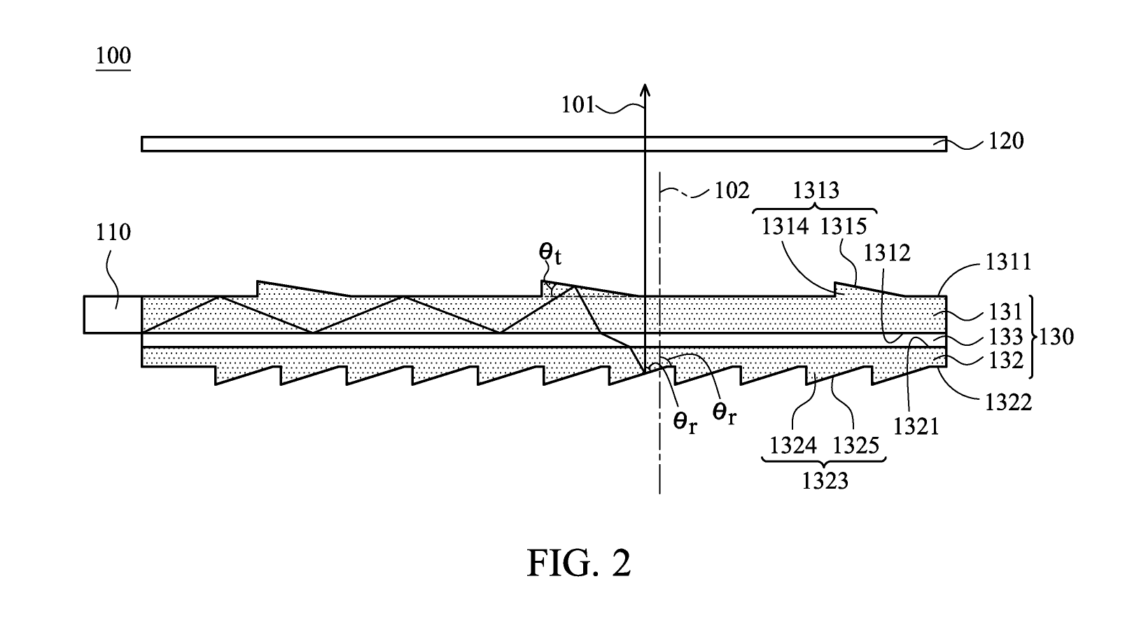

FIG. 2 shows a display 100 of a first embodiment of the invention. The display 100 includes a light source 110, a brightness enhanced film 120 and a light guide 130. The light guide 130 comprises a guiding layer 131, a reflective layer 132 and an intermediary layer 133.

The guiding layer 131 comprises a first upper surface 1311 and a first lower surface 1312. The first upper surface 1311 is opposite to the first lower surface 1312. The first upper surface 1311 faces to the brightness enhanced film 120. A guiding layer micro-structure 1313 is formed on the first upper surface 1311 to improve uniformity of light. The guiding layer 131 has a guiding layer refractive index.

The reflective layer 132 comprises a second upper surface 1321 and a second lower surface 1322. The second upper surface 1321 is opposite to the second lower surface 1322. A reflective layer micro-structure 1323 is formed on the second lower surface 1322 to control and focus the direction of light. The reflective layer 132 has a reflective layer refractive index.

The intermediary layer 133 is sandwiched between the guiding layer 131 and the reflective layer 132, and contacts the first lower surface 1312 of the guiding layer 131 and the second upper surface 1321 of the reflective layer 132. The intermediary layer 133 has an intermediary layer refractive index (n₂), and the intermediary layer refractive index (n₂) is smaller than the guiding layer refractive index (n₁) and the reflective layer refractive index (n₁).

In this embodiment, the guiding layer 131 and the reflective layer 132 are made of Polymethylmethacrylate (PMMA) or materials with a refractive index of 1.49˜1.59, and the intermediary layer 133 is made of Teflon or other materials with a refractive index about 1˜1.48. The intermediary layer refractive index (about 1˜1.48) of the intermediary layer 133 is smaller than the guiding layer refractive index and the reflective layer refractive index. The thickness of the guiding layer 131 is greater than the thickness of the light source (light emitting diode chip) 110. The thicknesses of the reflective layer 132 and the intermediary layer 133 are between 0.2 mm˜10 mm.

With reference to FIG. 2, the light source 110 provides a light 101. The light 101 enters the guiding layer 131 from the light source 110. Since the intermediary layer refractive index (n₂) is smaller than the guiding layer refractive index (n₁), the lights 101 according to different incident angles are reflected by the intermediary layer 133, or, pass through the intermediary layer 133. The light 101 reflected by the intermediary layer 133 travels between the first upper surface 1311 and the first lower surface 1312, and passes through the intermediary layer 133 after being reflected by the guiding layer micro-structure 1313 with changed angle thereby. The light 101 passing through the intermediary layer 133 is reflected by the reflective layer micro-structure 1323, passing through the intermediary layer 133 again and the guiding layer 131 to be emitted toward the brightness enhanced film 120.

In the first embodiment of the invention, the intermediary layer with lower refractive index is disposed between the guiding layer and the reflective layer. The intermediary layer helps to control directions of the light. Without the intermediary layer, the light cannot be sufficiently guided by the guiding layer, thereby the function of the guiding layer is invalid. Utilizing the first embodiment of the invention, the display can provide highly-collimating light with a simple reflective layer micro-structure 1323.

In the first embodiment of the invention, an angle θᵣ is formed between the reflective layer micro-structure 1323 and a normal line 102. The normal line 102 is perpendicular to the first lower surface 1312. The angle θᵣ, the intermediary layer refractive index (n₂), the guiding layer refractive index (n₁), and the reflective layer refractive index (n₁) satisfies the following formula:

θᵣ=90°−1/2*sin⁻¹(n₂/n₁)

In this embodiment, the guiding layer micro-structure 1313 comprises a plurality of guiding layer triangular prisms 1314, and the guiding layer triangular prisms 1314 are parallel to each other. Each guiding layer triangular prism 1314 has a guiding layer prism surface 1315, and an angle θₜ between the guiding layer prism surface 1315 and the first upper surface 1311 is 1˜8 degrees. The guiding layer prism surfaces 1315 are parallel to each other. The reflective layer micro-structure 1323 comprises a plurality of reflective layer triangular prisms 1324, and the reflective layer triangular prisms 1324 are parallel to each other. Each reflective layer triangular prism 1324 has a reflective layer prism surface 1325, and an angle θᵣ between the reflective layer prism surface 1325 and the normal line 102 is 45˜71 degrees. The dimension of the cross section of the prisms is about 10 μm˜300 μm. The range of the angles and the dimension mentioned above can be modified, which do not restrict the invention.

In the embodiment of the invention, the guiding layer 130 provides single dimensional collimation. The brightness enhanced film 120 has a brightness enhancing micro-structure. The brightness enhancing micro-structure is substantially perpendicular to the guiding layer micro-structure 1313 and the reflective layer micro-structure 1323 to provide collimation of another dimension.

In the embodiment, due to the large difference between the reflective layer refractive index and the air refractive index, a reflective film is prevented from being disposed on the second lower surface 1322. However, the invention is not limited to the disclosed embodiments. In a modified example, a reflective film can be applied on the second lower surface 1322.

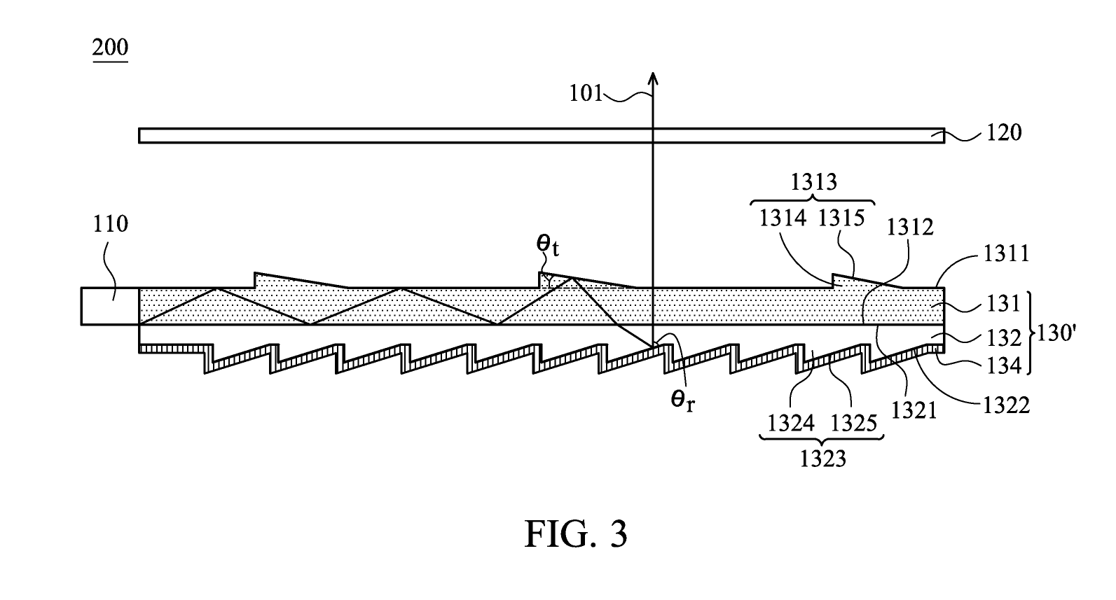

FIG. 3 shows a display 200 of a second embodiment of the invention. Similar to the first embodiment, the display 200 includes a light source 110, a brightness enhanced film 120 and a light guide 130′. The characteristics of the second embodiment are that the light guide 130′ has a guiding layer 131, a reflective layer 132 and a reflective film 134, and the intermediary layer 133 is omitted. The guiding layer 131 has a guiding layer refractive index, and the reflective layer 132 has a reflective layer refractive index, wherein the reflective layer refractive index is smaller than the guiding layer refractive index. For example, the guiding layer 131 can be made of PMMA or materials with a refractive index of 1.49˜1.59, and the reflective layer 132 can be made of Teflon or materials with a refractive index of 1˜1.48. In this embodiment, the material of the reflective layer 132 helps to share the controlling function of the light directions, and the display provides highly-collimating light with a simple reflective layer micro-structure. The reflective film 134 is disposed on a second lower surface 1322 of the reflective layer 132. In this embodiment, the light 101 enters the guiding layer 131 from the light source 110. Because of the reflective layer refractive index is smaller than the guiding layer refractive index, the lights 101 according to different incident angles are reflected by the reflective layer 132, or, pass through the reflective layer 132. The light 101 reflected by the reflective layer 132 travels between the first upper surface 1311 and the first lower surface 1312, and enters the reflective layer 132 after being reflected by the guiding layer micro-structure 1313 with changed traveling direction. The light 101 entering the reflective layer 132 is reflected by the reflective layer micro-structure 1323 and the reflective film 134, passing through the guiding layer 131 to be emitted toward the brightness enhanced film 120.

The display 200 of the second embodiment differs from the display 100 of the first embodiment in that the difference between the reflective layer refractive index and air refractive index is smaller, and the reflective film 134 is therefore required.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light guide, comprising:
a guiding layer, comprising a first upper surface and a first lower surface, wherein a guiding layer micro-structure is formed on the first upper surface, and the guiding layer has a guiding layer refractive index;
a reflective layer, comprising a second upper surface and a second lower surface, wherein a reflective layer micro-structure is formed on the second lower surface, and the reflective layer has a reflective layer refractive index;
an intermediary layer, sandwiched between the guiding layer and the reflective layer, contacting the first lower surface of the guiding layer and the second upper surface of the reflective layer, wherein the intermediary layer has an intermediary layer refractive index, and the intermediary layer refractive index (n₂) is smaller than the guiding layer refractive index and the reflective layer refractive index.

2. The light guide as claimed in claim 1, wherein the guiding layer refractive index is equal to the reflective layer refractive index (n₁).

3. The light guide as claimed in claim 2, wherein an angle θᵣ is formed between the reflective layer micro-structure and a normal line, and the normal line is perpendicular to the first lower surface, and the angle θᵣ, the intermediary layer refractive index (n₂), the guiding layer refractive index (n₁), and the reflective layer refractive index (n₁) satisfies the following formula:
θᵣ=90°−1/2*sin⁻¹(n₂/n₁)

4. The light guide as claimed in claim 2, wherein the guiding layer micro-structure comprises a plurality of guiding layer triangular prisms, and the guiding layer triangular prisms are parallel to each other.

5. The light guide as claimed in claim 4, wherein each guiding layer triangular prism has a guiding layer prism surface, and an angle θₜ between the guiding layer prism surface and the first upper surface is 1˜8 degrees.

6. The light guide as claimed in claim 2, wherein the reflective layer micro-structure comprises a plurality of reflective layer triangular prisms, and the reflective layer triangular prisms are parallel to each other.

7. The light guide as claimed in claim 6, wherein each reflective layer triangular prism has a reflective layer prism surface, and an angle θᵣ between the reflective layer prism surface and the normal line is 45˜71 degrees.

8. The light guide as claimed in claim 2, wherein the guiding layer refractive index and the reflective layer refractive index are between 1.49˜1.59, and the intermediary layer refractive index is between 1˜1.48.

9. The light guide as claimed in claim 1, wherein thicknesses of the reflective layer and the intermediary layer are between 0.2 mm˜10 mm.

10. A display, comprising:
a light source, providing a light;
a brightness enhanced film; and
a light guide, comprising:
a guiding layer, comprising a first upper surface and a first lower surface, wherein the first upper surface is opposite to the first lower surface, the first upper surface faces to the brightness enhanced film, a guiding layer micro-structure is formed on the first upper surface, the guiding layer has a guiding layer refractive index, and the light enters the guiding layer from the light source;
a reflective layer, comprising a second upper surface and a second the second lower surface, a reflective layer micro-structure is formed on the second lower surface, and the reflective layer has a reflective layer refractive index;
an intermediary layer, sandwiched between the guiding layer and the reflective layer, contacting the first lower surface of the guiding layer and the second upper surface of the reflective layer, wherein the intermediary layer has an intermediary layer refractive index, and the intermediary layer refractive index (n₂) is smaller than the guiding layer refractive index and the reflective layer refractive index, wherein the light travels from the guiding layer, passes through the intermediary layer to the reflective layer, is reflected by the reflective layer micro-structure, and passes through the intermediary layer and the guiding layer to be emitted toward the brightness enhanced film.

11. The display as claimed in claim 10, wherein the guiding layer refractive index is equal to the reflective layer refractive index (n₁).

12. The display as claimed in claim 11, wherein an angle θᵣ is formed between the reflective layer micro-structure and a normal line, and the normal line is perpendicular to the first lower surface, and the angle θᵣ, the intermediary layer refractive index (n₂), the guiding layer refractive index (n₁), and the reflective layer refractive index (n₁) satisfies the following formula:
θᵣ=90°−1/2*sin⁻¹(n₂/n₁)

13. The display as claimed in claim 11, wherein the guiding layer micro-structure comprises a plurality of guiding layer triangular prisms, and the guiding layer triangular prisms are parallel to each other.

14. The display as claimed in claim 13, wherein each guiding layer triangular prism has a guiding layer prism surface, and an angle θₜ between the guiding layer prism surface and the first upper surface is 1˜8 degrees.

15. The display as claimed in claim 11, wherein the reflective layer micro-structure comprises a plurality of reflective layer triangular prisms, and the reflective layer triangular prisms are parallel to each other.

16. The display as claimed in claim 15, wherein each reflective layer triangular prism has a reflective layer prism surface, and an angle θᵣ between the reflective layer prism surface and the normal line is 45˜71 degrees.

17. The display as claimed in claim 11, wherein the guiding layer refractive index and the reflective layer refractive index are between 1.49˜1.59, and the intermediary layer refractive index is between 1˜1.48.

18. The display as claimed in claim 10, wherein thicknesses of the reflective layer and the intermediary layer are between 0.2 mm˜10 mm.

19. A light guide, comprising:
a guiding layer, comprising a first upper surface and a first lower surface, wherein the first upper surface is opposite to the first lower surface, a guiding layer micro-structure is formed on the first upper surface, and the guiding layer has a guiding layer refractive index;
a reflective layer, comprising a second upper surface and a second lower surface, wherein the second upper surface is opposite to the second lower surface, a reflective layer micro-structure is formed on the second lower surface, the second upper surface contacts the first lower surface, and the reflective layer has a reflective layer refractive index, wherein the reflective layer refractive index is smaller than the guiding layer refractive index; and
a reflective film, disposed on the second lower surface.

20. A display, comprising:
a light source, providing a light;
a brightness enhanced film; and
the light guide as claimed in claim 19, wherein the first upper surface faces to the brightness enhanced film, and the light enters the guiding layer from the light source, wherein the light travels from the guiding layer, passes through the reflective layer to the reflective film, is reflected by the reflective film, and passes through the reflective layer and the guiding layer to be emitted toward the brightness enhanced film.
